(19) United States
(12) Patent Application Publication
(10) Pub. No.: US 2015/0255202 A1
(43) Pub. Date: Sep. 10, 2015

(54) SYSTEM AND METHOD FOR IMPACT ON THE- STRUCTURE OF SUBSTANCES BY MEANS OF LOW ENERGY MODULATED MAGNETIC FIELD

(71) Applicant: Urie Perov MARKOV, Dobrich (BG)

(72) Inventor: Urii Petrov Markov, Dorbich (BG)

(21) Appl. No.: 14/424,043

(22) PCT Filed: Apr. 1, 2013
(86) PCT No.: PCT/BG2013/000011

§ 371 Date: Feb. 26, 2015

(30) Foreign Application Priority Data
Aug. 29, 2012 (BG) 111298

(51) Int. Cl. H01F 7/06

(52) U.S. Cl. CPC H01F 7/064

(57) ABSTRACT

System and method for impact on the structure of substances by means of low energy modulated magnetic field (57). System for creation of low energy modulated magnetic field, characterized in that it includes a control module (1) with specialized software, two-way connected with a modulating device (2) and a source of modulated magnetic field (3), whereby the modulating device (2) includes a mutually connected generator or synthesizer of sinusoidal modulating signal (4), a digital analogue converter (DAC) (5) and an amplifier (6), and is connected to the source of modulated magnetic field (3), which represents at least one solenoid. Method for impact on the charge exchange and the condition of substances by means of low energy modulated magnetic field, characterized in that it includes the following operations in their sequence:—determination of the object for impact means of low energy modulated magnetic field;—analysis and calculation of the modulating energy depending on the characteristic features of the concrete object in a frequency range from 1⁻¹⁰ Hz to 1²⁰ Hz;—generation, saving and production of the concrete modulated signal parameters to create an impact zone (7);—effecting an impact on the concrete object by means of low energy modulated magnetic field in the impact zone (7).

### FIELD OF THE INVENTION

The invention relates to system and method, creating conditions for controlled low energy impact on the fulfillment of chemical and physical processes in solutions and other material media and will find application in the industry.

### BACKGROUND AND PRIOR ART

There are known systems and methods for impact by means of electromagnetic fields on a number of processes in different industrial fields, communications, ecology and medicine. Electromagnetic fields with different power strength are often used to create low-frequency and high-frequency waves for measuring of aggressive liquid flows, detecting defects in the production of different mechanical parts, diagnostics and treatment of several diseases and anomalies, trauma treatments and rehabilitation in the medicine.

Magnetic fields are utilized also for manufacturing of particle accelerators to obtain isotopes, sensors for different purposes, movement of transport mechanisms, production of magnetic bearings, which represent a servo stabilizer electronic system complex to keep stable the rotating pails geometry etc.

Different systems and methods, based on the application of magnetic and electromagnetic fields, are used in science for basic and applied research, such as cyclotrons, betatrons, microtrons, linear accelerators etc. All these and similar systems and appliances serve for learning the processes, which happen on micro and macro level.

### DISCLOSURE OF THE INVENTION

The invention is aimed at creating system and method for impact on preselected physical and chemical processes of charge transfers in liquid and solid media, by means el modulated low energy magnetic field.

The invention task is solved by system and method for impact on the charge exchange and the condition of substances by means of low energy modulated magnetic field, subject of the present invention, whereby the system for creation of low energy modulated magnetic field includes a control module with specialized software, two-way connected with a modulating device and a source of modulated magnetic field. The modulating device on its part includes a mutually connected generator or synthesizer of sinusoidal modulating signal, a digital analogue converter (DAC) and an amplifier, and is connected to the source of modulated magnetic field, which represents at least one solenoid with magnetic core.

In accordance with an embodiment of the invention, the source of modulated magnetic field of the system for creation of low energy modulated magnetic field represents at least one solenoid without magnetic cores.

The method for impact on the charge exchange and the condition of substances by means of low energy modulated magnetic field is realized through the following operations:
determination of the object for impact by means of low energy modulated magnetic field;
analysis and calculation of the modulating energy depending on the characteristic features of the concrete object in a frequency range from 1⁻¹⁰ Hz to 1²⁰ Hz;
generation, saving and reproduction of the concrete modulated signal parameters to create an impact zone;
effecting an impact on the concrete object by means of low energy modulated magnetic field in the impact zone.

The proposed system and method give the possibility of selected acceleration or retardation of the charge exchange in substances, giving opportunities for efficient and economy-priced productions by means of more complete utilization of the initial raw materials. It is possible to exercise control and to determine the availability and the content of different substances in a material media.

In the scientific field an opportunity will be afforded to learn processes of substance transformation by means of energy and information transfers under low energy levels from one material object to the other, creation of new substances with previously programmed characteristic features, products with preset parameters, creation and development of already existing technologies.

The proposed system and method will find a wide field of application in the ecology for the purposes of the catalytic air and water purification processes. In the medicine they will be applied in the research and development of new products and therapies for diagnostics, treatment and rehabilitation.

### EXPLANATION OF THE ENCLOSED FIGURES

The system and the method for impact on the charge exchange and the condition of substances by means of low energy modulated magnetic field are explained, but not limited by the following figures, where:

FIG. 1 represents a principal scheme of a system for creation of low energy modulated magnetic field.

FIG. 2: Exemplary embodiment of the system, whereby solenoids with magnetic cores are used as a source of modulated magnetic field.

FIG. 3: Exemplary embodiment of the system and the method for impact on the charge exchange and the condition of substances by means of low energy modulated magnetic field on a galvanic pair.

FIG. 4: Exemplary embodiment of the system and the method for impact by means of low energy modulated magnetic field on a capacitor.

### EXEMPLARY EMBODIMENT OF THE INVENTION

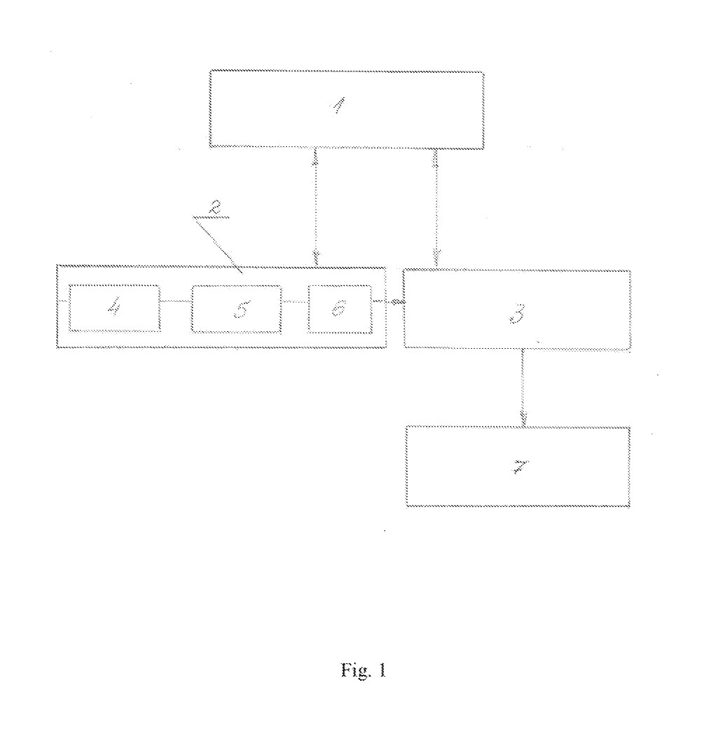

In accordance with the enclosed FIG. 1, the system for creation of low energy modulated magnetic field includes a control module 1 with specialized software, two-way connected with a modulating device 2 and a source of modulated magnetic field 3. The modulating device 2 on its part is connected to the source of modulated magnetic field 3 and includes a mutually connected generator or synthesizer of sinusoidal modulating signal 4, a digital analogue converter (DAC) 5 and an amplifier 6. The source of modulated magnetic field 3 includes at least one solenoid or solenoid group with magnetic core(s).

The control device 1 is designated to control processes temporally. The generator, or the synthesizer, of sinusoidal modulating signal 4 has preset characteristic parameters with regard to the object of impact in a frequency range from 1⁻¹⁰ Hz to 1²⁰ Hz, while the generated sinusoidal signal is transferred to the digital analogue converter (DAC) 5. Depending on the applications or the size of the object for impact, the modulating signal, generated by the synthesizer 4 and transferred to the digital analogue converter 5, can be amplified through an amplifier 6.

The source of modulated magnetic field 3 represents at least one solenoid or solenoid group with magnetic cores. These magnetic cores create a permanent magnetic field with preset topology.

According to an embodiment of the invention, the source of modulated magnetic field 3 can be at least one solenoid or solenoid group without magnetic cores. If no magnetic cores are used, the modulation is applied directly on the electric current, which creates the electromagnetic field.

The method for impact on the structure of substances by means of low energy modulated magnetic field includes the following operations in their sequence:
determination of the object for impact by means of low energy modulated magnetic field;
analysis and calculation of the modulating energy depending on the characteristic features of the concrete object in a frequency range from 1⁻¹⁰ Hz to 1²⁰ Hz;
generation, saving and reproduction of concrete modulated signal parameters to create an impact zone 7;
effecting an impact on the concrete object by means of low energy modulated magnetic field.

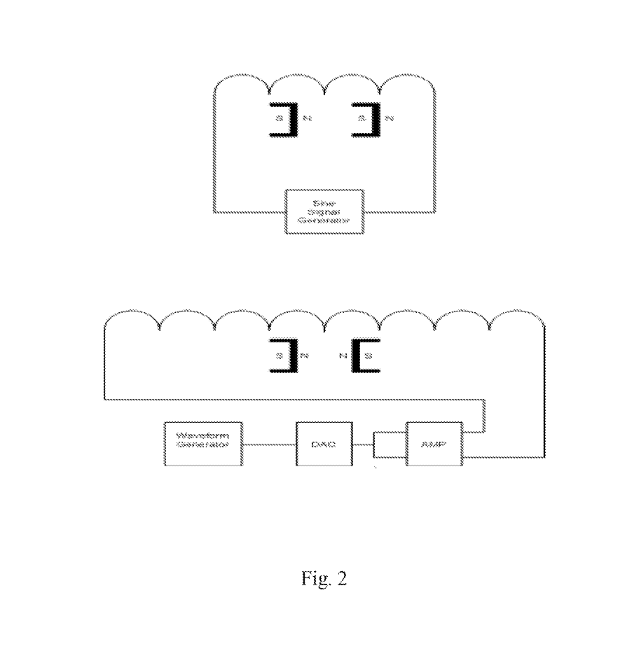

In accordance with the enclosed FIG. 2, the system for creation of low energy modulated magnetic field consists of modulating device 2, including a synthesizer of sinusoidal signals 4 and a digital analogue device 5, as well as a source of modulated magnetic field 3, including a solenoid, or a solenoid system with magnetic cores.

According to another embodiment of the invention, FIG. 2a shows a scheme of the system for impact by means of low energy modulated magnetic field, whereby the permanent magnets in the solenoids are located face to face with their poles of opposite charge.

According to another embodiment of the invention, FIG. 2b shows a scheme of the system for impact by means of low energy modulated magnetic field, whereby the permanent magnets in the solenoids are located face to face with their poles of equal charge.

The proposed system and method for impact on the charge exchange and the condition of substances by means of low energy modulated magnetic field are illustrated and exemplified, but not limited by the following examples.

### EXAMPLE 1

It is well-known in the literature, that the electrode potential alterates depending on the outer current flow amperage and direction. It is known, that the potential alteration, caused by a current, flowing through the electrode, is called polarization. The current in a certain system can flow also under external physical impact, such as light, electromagnetic impact or radiation exposure.

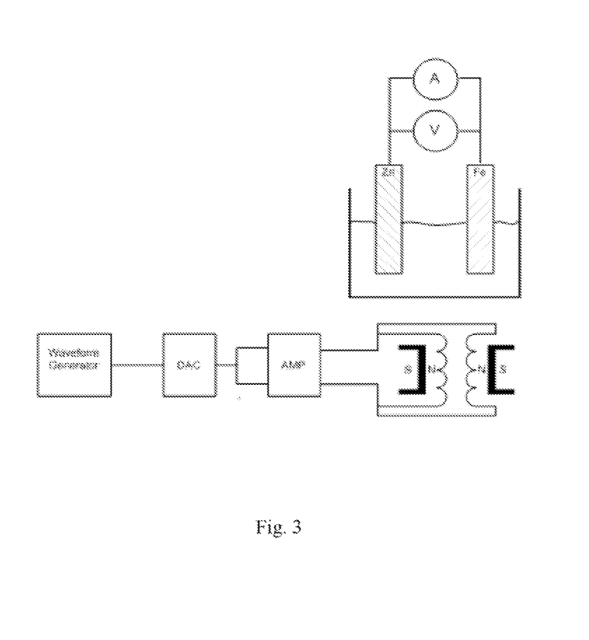

In accordance with the enclosed FIG. 3, in the present case a galvanic element is used, which consists of one zinc electrode and one iron electrode with equal geometric dimensions, dipped in a vessel with 18% sulfuric acid solution. The potential difference between the zinc electrode and the iron electrode without current flow, i.e. by open circuit, is 529 mV. If we put the same galvanic element under impact of a modulated magnetic field in the impact zone 7, created by the described system, whereby the source of the modulated magnetic field 3 consists of two solenoids, the potential difference by open circuit becomes 517 mV. The modulation frequency is 35-36 kHz and the power is 200 mW.

The experiment is repeated, while both electrodes—the zinc and the iron one, are shorted-out through conductor of minimal resistance. In this situation, without impact by means of modulated magnetic field, the potential difference between the zinc and the iron electrodes becomes 450 μV, and the maximal corrosion current, which flows between both electrodes without impact by means of modulated magnetic field, is 9.5 μA. When we put the galvanic element under impact of modulated magnetic field in the impact zone 7, the potential difference between both electrodes becomes 200 μV, while the maximal corrosion current, which flows between both electrodes under impact of modulated magnetic field, becomes 3 μA.

### EXAMPLE 2

It is known, that capacitors represent passive electronic elements for temporary energy storage, whereby a static electric field arises in the dielectric in case of potential difference between both capacitor electrodes. It defines to a great extent the capacitor facilities to be efficient charged with different quantities of energy for a determined time period and respectively to store this energy for a long period.

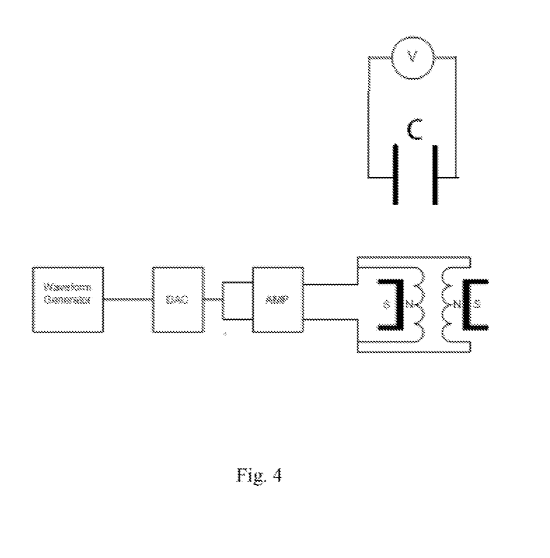

For the purposes of this example according to the enclosed FIG. 4, there are chosen two new electrolytic capacitors with initial opposite polarity. A digital voltmeter is used to find out the opposite polarity, while the opposite polarity is expressed by the negative potential, measured between the positive and the negative capacitor electrodes. The capacitors' capacity has not been measured and their electrodes have not been shorted-out.

One of the capacitors is used as a control capacitor. The control capacitor is plugged in to a digital voltmeter, connected with a personal computer. No impact by means of modulated magnetic field has been applied on the control capacitor. The second capacitor is put in the impact zone with a modulated magnetic field, while its potential is measured continuously through the connected with a PC voltmeter. An impact by means of special modulated magnetic field, created by the system, including a source of modulated magnetic field 3, which comprises two solenoids, is applied on the second capacitor. The modulation frequency is 35-36 kHz and the power is 200 mW.

During the executed experiment it is determined, that the control capacitor does not change its negative polarity. The capacitor under impact by means of modulated magnetic field is charged gradually by value of +2 mV/h. Depending on the potential initially measured, this inverts its polarity in positive direction within several hours. During the experiment only digital measuring instruments are used.

1. System for creation of low energy modulated magnetic field, characterized in that it includes a control module (1) with specialized software, two-way connected with a modulating device (2) and a source of modulated magnetic field (3), whereby the modulating device (2) includes mutually connected generator or synthesizer of sinusoidal modulating signal (4), a digital analogue converter (DAC) (5) and an amplifier (6), and is connected to the source of modulated magnetic field (3), which represents at least one solenoid with magnetic core.

2. System for creation of low energy modulated magnetic field according to claim 1, characterized in that the source of modulated magnetic field represents at least one solenoid without magnetic cores.

3. Method for impact on the charge exchange and the condition of substances by means of low energy modulated magnetic field, characterized in that it includes the following operations in their sequence:
determination of the object for impact by means of low energy modulated magnetic field;
analysis and calculation of the modulating energy depending on the characteristic features of the concrete object in a frequency range from 1⁻¹⁰ Hz to 1²⁰ Hz;
generation, saving and reproduction of the concrete modulated signal parameters to create an impact zone (7);
effecting an impact on the concrete object by means of low energy modulated magnetic field in the impact zone (7).
